(19) United States
(12) Patent Application Publication
(10) Pub. No.: US 2023/0059338 A1
(43) Pub. Date: Feb. 23, 2023

(54) SYSTEMS AND METHODS FOR ELECTRICITY GENERATION

(71) Applicant: National Oilwell Varco, L.P., Houston, TX (US)

(72) Inventors: Travis James Miller, Cypress, TX (US); Paul Sanghyun Park, Katy, TX (US); James William Weir, Cypress, TX (US)

(73) Assignee: National Oilwell Varco, L.P., Houston, TX (US)

(21) Appl. No.: 17/891,445

(22) Filed: Aug. 19, 2022

Related U.S. Application Data
(60) Provisional application No. 63/235,540, filed on Aug. 20, 2021.

(51) Int. Cl. H02K 7/18; F04F 10/00; F03B 13/06

(52) U.S. Cl. CPC H02K 7/1823; F04F 10/00; F03B 13/06; F05B 2220/604; F05B 2220/706

(57) ABSTRACT

A system includes a wellbore that extends from a surface into a subterranean formation. In addition, the system includes a power generation assembly including a fluid circuit that is in fluid communication with the wellbore wherein the power generation assembly is configured to generate electricity in response to a flow of a working fluid through the fluid circuit. Further, the system includes a bubble pump positioned within the wellbore that is configured to circulate the working fluid between the fluid circuit of the power generation assembly and the wellbore via a thermosiphon effect.

### CROSS-REFERENCE TO RELATED APPLICATIONS

This application claims benefit of U.S. provisional patent application Ser. No. 63/235,540 filed Aug. 20, 2021, and entitled “Systems and Methods For Electrical Power Generation,” which is hereby incorporated herein by reference in its entirety.

### STATEMENT REGARDING FEDERALLY SPONSORED RESEARCH OR DEVELOPMENT

Not applicable.

### BACKGROUND

Wellbores are commonly drilled from the surface to access minerals or other resources (e.g., oil, gas, water, etc.) that exist within subterranean formations. The internal heat of the Earth (e.g., residual heat from the Earth's formation, heat generated by radioactive elements beneath the Earth's surface, etc.) typically induces an increasing temperature gradient per increasing depth within such wellbores (e.g., at a rate of approximately 1° F. per 70 vertical feet in some locations). The elevated temperatures within these wellbores are potential sources of energy that may be harnessed to provide power (e.g., electrical power) at the surface.

### BRIEF SUMMARY

Some embodiments disclosed herein are directed to a system including a wellbore that extends from a surface into a subterranean formation. In addition, the system includes a power generation assembly comprising a fluid circuit that is in fluid communication with the wellbore. The power generation assembly is configured to generate electricity in response to a flow of a working fluid through the fluid circuit. Further, the system includes a bubble pump positioned within the wellbore that is configured to circulate the working fluid between the fluid circuit of the power generation assembly and the wellbore via a thermosiphon effect.

Some embodiments disclosed herein are directed to a method including (a) circulating a working fluid between a wellbore and a power generation assembly via a thermosiphon effect, wherein the wellbore extends from a surface into a subterranean formation. In addition, the method includes (b) flowing the working fluid through a fluid circuit of the power generation assembly. Further, the method includes (c) generating electricity with the power generation assembly as a result of (b).

Some embodiments disclosed herein are directed to a system including a wellbore that extends from a surface into a subterranean formation. In addition, the system includes a power generation assembly comprising a generator and a turbine mechanically coupled to the turbine. Actuation of the turbine is configured to actuate the generator to generate electricity. Further, the system includes a bubble pump positioned within the wellbore that is configured to circulate a working fluid between the turbine and the wellbore via a thermosiphon effect to actuate the turbine.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic diagram of a geothermal power generation system according to some embodiments;

FIG. 2 is a piping and instrumentation diagram of a power generation assembly of the system of FIG. 1 according to some embodiments;

FIGS. 3A-3C are side cross-sectional views of a geothermal power generation system according to some embodiments; and

FIG. 4 is a schematic diagram of a geothermal power generation system according to some embodiments.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. As used herein, the terms substantial, substantially, generally, about, approximately, and the like, when applied to a stated value mean +1-10% of the stated value. Finally, any reference to up or down in the description and the claims is made for purposes of clarity, with “up”, “upper”, “upwardly”, or “uphole” meaning toward the surface of the wellbore or borehole and with “down”, “lower”, “downwardly”, or “downhole” meaning toward the terminal end of the wellbore or borehole, regardless of the wellbore or borehole orientation.

As previously described above, elevated temperatures found within the lower regions of subterranean wellbores are a potential thermal energy source that may be harnessed to generate power (e.g., electrical power) for use at the surface. One common type of wellbore that is formed in a subterranean formation is that associated with an oil and gas well. Typically, these wells may be drilled to a depth of 5000 to 10000 feet below the surface (depending the specific location), and may have a bottom hole temperature close to or over 300° F. There are a great number of such wells that have been drilled to access oil and gas reserves worldwide over the last two centuries.

Therefore, embodiments disclosed herein include systems and methods for extracting geothermal energy emitted into a subterranean wellbore, such as, for example, a wellbore previously drilled to access oil and/or gas deposits. Accordingly, through use of the embodiments disclosed herein, the geothermal energy of the Earth may be efficiently harnessed to generate electrical power.

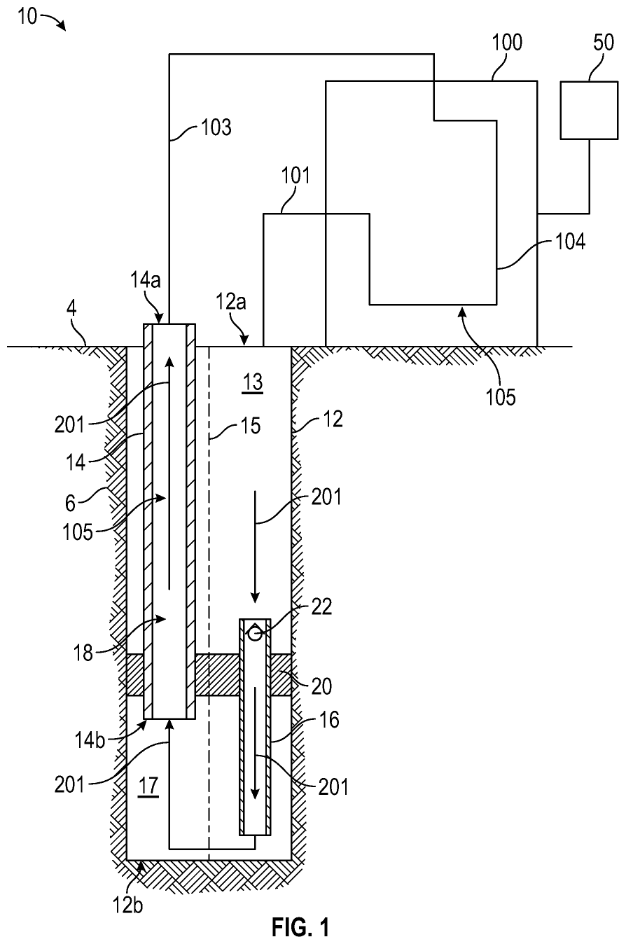

Referring now to FIG. 1, a geothermal power generation system 10 (or more simply “system 10”) according to some embodiments is shown. System 10 generally includes a wellbore 12 extending into a subterranean formation 6 from the surface 4. Wellbore 12 includes a central axis 15, a first end or upper end 12a, and a second or lower end 12b opposite upper end 12a. Upper end 12a is disposed at the surface 4, and lower end 12b is disposed within the subterranean formation 6. In this embodiment, wellbore 12 is substantially vertical, such that axis 15 is generally aligned with the vertical direction (e.g., along the direction of gravity). However, in other embodiments, one or more sections or portions of wellbore 12 may be non-vertically oriented (e.g., lateral).

A packer 20 (or other suitable sealing device or assembly) may be positioned within the wellbore 12 that is to separate the wellbore 12 into a first or upper section 13 extending from upper end 12a toward packer 20, and a second or lower section 17 extending from packer 20 to lower end 12b. The packer 20 may provide a seal within the wellbore 12 so that upper section 13 is generally isolated from lower section 17 via packer 20 (except as described in more detail below).

A plurality of flow paths may extend through packer 20 to communicate fluid across the packer 20 between the upper section 13 and lower section 17. An outlet tubular string 14 (or more simply “outlet string 14”) is positioned within the wellbore 12 that extends through the packer 20. Outlet string 14 (which may comprise a plurality of tubular members connected end-to-end) has a first or upper end 14a that is positioned at the surface 4 (or proximate surface 4 within upper section 13), and a second or lower end 14b positioned within lower section 17. Thus, outlet string 14 may define an outlet flow path that extends uphole from the lower section 17 (e.g., to the surface 4). In addition, an inlet flow path 16 extends through packer 20, between upper section 13 and lower section 17 that is separate from outlet string 14. A one-way valve (e.g., a check valve) 22 may be positioned within inlet flow path 16 that is to allow fluid to flow through packer 20 from upper section 13 to lower section 17 via inlet flow path 16 but is to prevent fluid from flowing through packer 20 from lower section 17 to upper section 13 via inlet flow path 16. Thus, the inlet flow path 16 extends downhole within wellbore 12 toward lower end 12b and outlet flow path formed by outlet string 14 may extend from inlet flow path 16 (e.g., within lower section 17) toward the surface 4.

As previously described above, the internal temperature gradient of the Earth's crust results in an increasing temperature within the formation 6 and wellbore 12 when moving along axis 15 from the surface 4 toward lower end 12b. Thus, the temperature within wellbore 12 may be higher proximate lower end 12b than it is proximate upper end 12a. For instance, in some embodiments, the temperature within the upper section 13 may range from about 70° F. to about 180° F. whereas the temperature within the lower section 17 may range from about 180° F. to about 300° F. or more.

System 10 also includes a power generation assembly 100 positioned on surface 4, outside of wellbore 12, that is configured to harness this temperature gradient within the wellbore 12 to generate electricity. Once generated, the electricity may be delivered to a final location 50, which may include a local power grid, one or more batteries, capacitors, or other power storage assemblies. As is described in more detail below, in some embodiments, power generation assembly 100 may be replaced with another system, apparatus, machine, etc. that may utilize the harness the temperature gradient within the wellbore 12 for other purposes (e.g., to generate steam, heat transfer within a heat exchanger, water desalinization, to run a turbine). Thus, the specific disclosure related to use power generation assembly 100 is merely descriptive of some embodiments.

During operations, a working fluid (e.g., such as a refrigerant) 201 may be circulated between the power generation assembly 100 and the wellbore 12 for electrical power generation. Specifically, power generation assembly 100 includes a fluid circuit 104 that is fluidly coupled to, and thus is in fluid communication with, wellbore 12 (particularly to the inlet flow path 16 and outlet string 14). During operations, the power generation assembly 100 is configured to generate electricity when the working fluid 201 is circulated between the wellbore 12 the fluid circuit 104. Thus, a fluid loop or circuit 105 is established that includes and extends between fluid circuit 104 and wellbore 12 (particularly to the inlet flow path 16 and outlet string 14), and the working fluid is circulated along fluid loop 105 so as to drive electricity generation via power generation assembly 100.

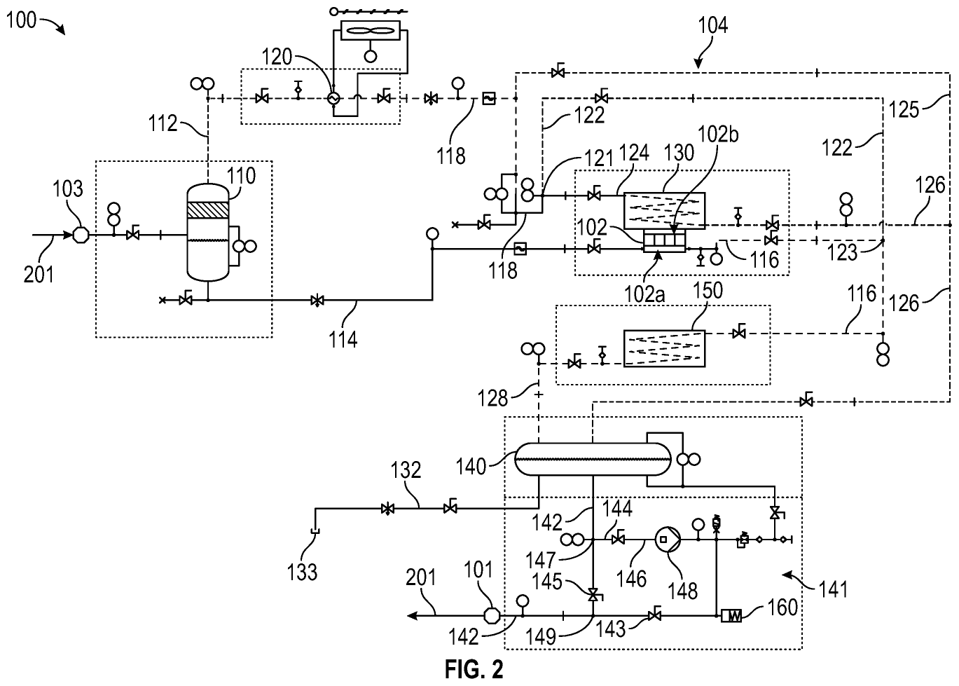

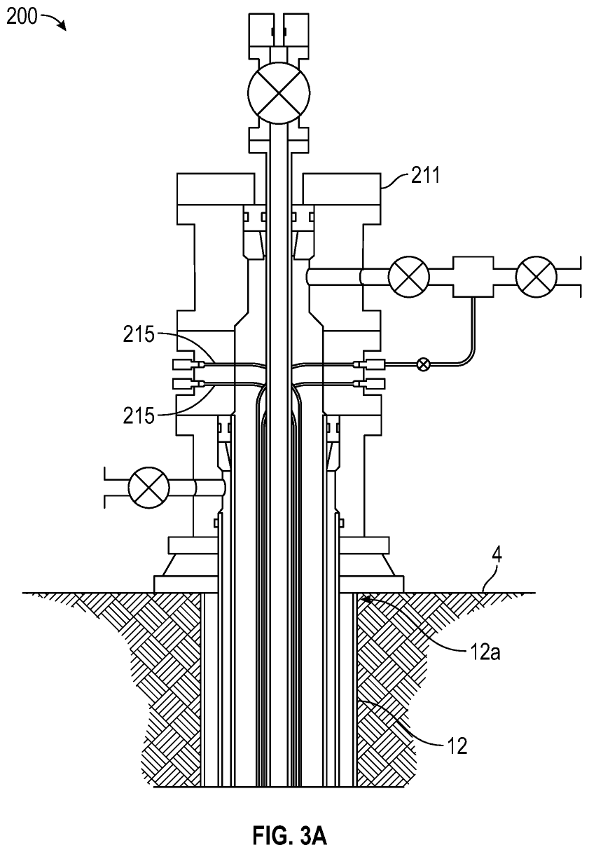

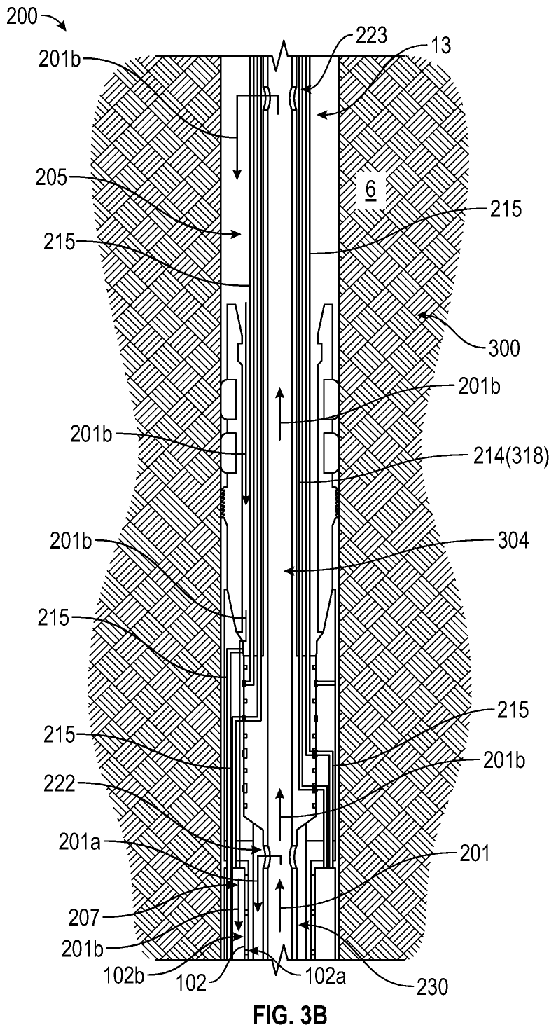

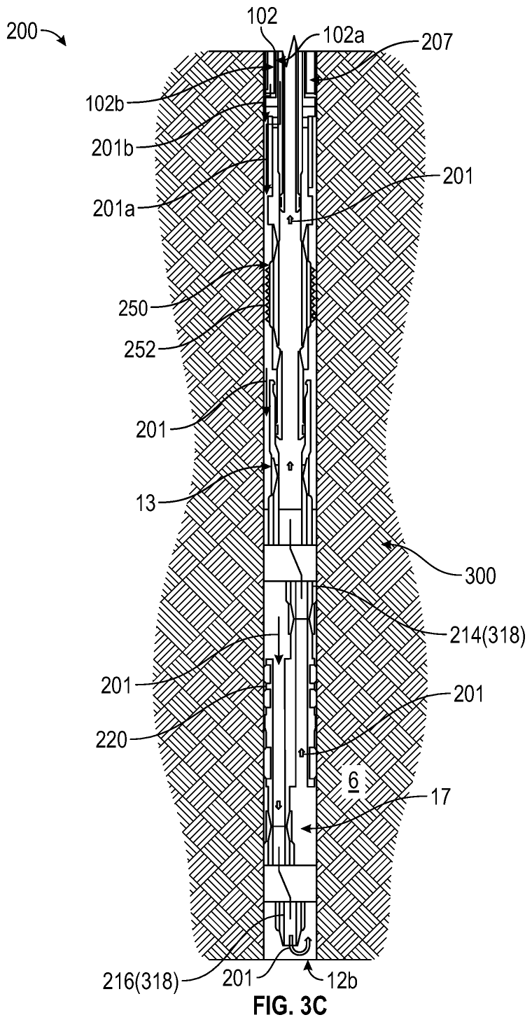

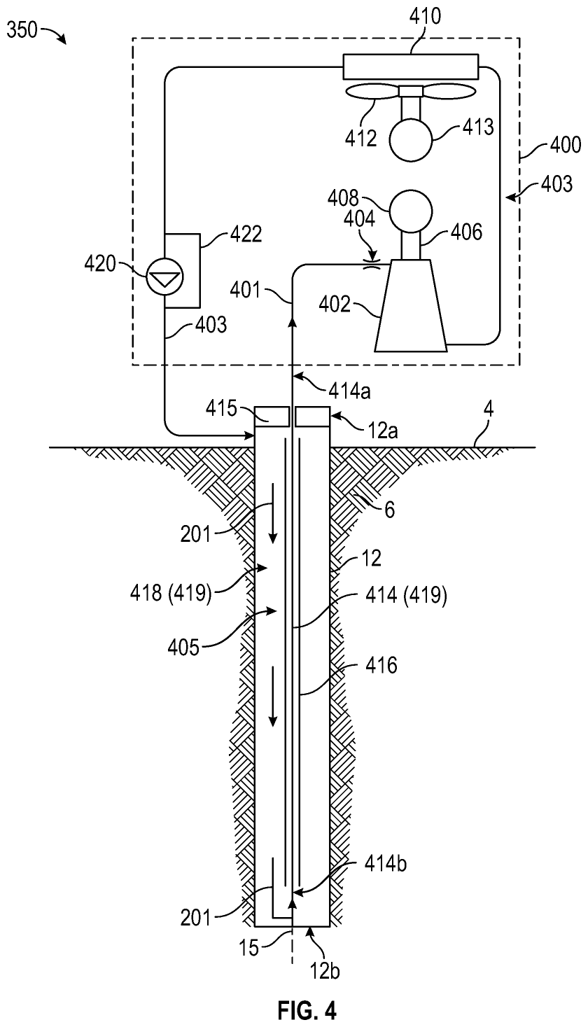

In some embodiments, the power generation assembly 100 may comprise an electric generator. For instance, in some embodiments, the power generation assembly 100 may comprise a thermoelectric generator (TEG) (e.g., TEG 102 shown in FIGS. 2, 3B, and 3C) that is configured to generate electric current when exposed to two different temperatures via the Seebeck Effect. The construction of TEG is well known and therefore, the details of such constriction are not described in detail herein; however, in general a TEG may include dissimilar metallic materials that, when exposed to a temperature gradient, generate electric current. Thus, during operations, the working fluid 201 may carry the heat within formation 6 (e.g., particularly along lower section 17 of wellbore 12) to the TEG within power generation assembly 100 such that electrical power may be generated. In some embodiments, the power generation assembly 100 may include a generator that is mechanically coupled to a turbine (e.g., generator 408 and turbine 402 shown in FIG. 4). During operations, the working fluid is to flow through the turbine thereby diving the turbine to actuate the generator.

The working fluid 201 may comprise any suitable fluid or fluids that may be subjected to a phase change at temperatures expected within a subterranean formation. In some embodiments, the working fluid 201 may comprise a refrigerant, such as a hydrofluorocarbon (HFC). In some embodiments, the working fluid may comprise pentafluoropropane (C₃H₃F₅) which is sometimes referred to as R-245fa. In some embodiments, the working fluid 201 may comprise propane, or supercritical CO₂.

In some embodiments, the working fluid 201 may comprise a multi-component fluid, such as, for example, a two-component fluid. Thus, the working fluid 201 may comprise a first fluid and a second fluid. The first fluid may have a first boiling point, and the second fluid may have a second boiling point that is higher than the first boiling point. In some embodiments, the working fluid 201 circulated within wellbore 12 and power generation assembly 100 comprises an ammonia-water mixture (e.g., such that the ammonia may comprise the “first fluid” with the “first boiling point,” and the water may comprise the “second fluid” with the “second boiling point.”). However, it should be appreciated that other fluid combinations may be used in other embodiments, and the ammonia-water mixture discussed herein is merely one potential example multi-component working fluid 201 that may be circulated within power generation assembly 100 and wellbore 12.

During operations with system 10, the working fluid 201 may be heated by the formation 6 within lower section 17 and then lifted to the surface 4 via a thermosiphon effect generated by the differences in temperature (and thus also density) between two fluid columns (e.g., defined within and without the outlet string 14) within the wellbore 12. More specifically, during operations, the working fluid 201 may be flowed into wellbore 12 from via an inlet line 101 extending from power generation assembly 100. The working fluid 201 may then progress down upper section 13 of wellbore 12 toward lower end 12b, outside of outlet string 14 to packer 20. Thereafter, the working fluid 201 may progress through packer 20 into lower section 17 via inlet flow path 16. The higher temperature of formation 6 surrounding the lower section 17 may then cause the temperature of the working fluid 201 to increase, which may then result in an increased amount of natural (e.g., upward) convection in working fluid 201. In some embodiments, the temperature of the working fluid 201 may increase above the boiling point of at least one (e.g., both) of the components (e.g., ammonia and water) making up the working fluid 201. However, the relatively high pressure within the lower section 17 of wellbore 12 may prevent the working fluid 201 (or a component thereof) from boiling while in the lower section 17.

The hot working fluid 201 may flow into lower end 14b of outlet string 14 via the head pressure within wellbore 12 and convection-driven flow forces. As the hot working fluid 201 travels upward within the outlet string 14, the head pressure exerted on the fluid may decrease such that eventually, the hot working fluid 201 may begin to boil and produce gas bubbles that further drive the upward flow of the working fluid 201 toward upper end 14a of outlet string 14. In particular, in some embodiments, as the hot working fluid 201 progresses uphole within outlet string 14, the produced gas bubbles may produce a slug flow comprising alternating slugs of liquid and gas, so that the liquid working fluid 201 is effectively lifted to the surface 4 via the produced gases. Once at the surface, the working fluid 201 (e.g., as a two-phase flow of gas and liquid) may flow back to power generation assembly 100 from upper end 14a of outlet string 14 via an outlet line 103.

Thus, as previously described, the working fluid 201 is lifted from the lower section 17 to the surface 4 via the outlet string 14 by a thermosiphon effect that is generated by the thermal gradient within formation 6 and the resulting temperature, density, and pressure differences of the working fluid 201 within the wellbore 12. In this manner, the hot working fluid 201 is lifted within wellbore 12 and flowed back to power generation assembly without a separate mechanical pumping mechanism. Accordingly, the outlet string 14, packer 20 and inlet flow path 16 may be said to form a “bubble pump” 18 that lifts the fluid to surface 4 via the thermosiphon effect (and potentially also natural convection within lower section 17) as previously described. Without being limited to this or any other theory, the great depths of wellbore 12 (e.g., 5000 to 10000 feet below surface 4) may allow the length of outlet string 14 to be extended such that even relatively small differences in density and temperature within the working fluid 201 per unit length along outlet string 14 may be maximized to produce a sufficient flow rate to circulate working fluid 201 between the wellbore 12 and power generation assembly 100. Thus, as used herein the term “bubble pump” refers to an apparatus or system that defines a flow path for flowing a working fluid upward (e.g., against the force of gravity) by inducing a phase change (particularly vaporization) in the working fluid. As described herein, a bubble pump may drive fluid flow along a flow path (e.g., fluid loop 105) without the use of a mechanical pump.

In some embodiments, heat transfer may be minimized within upper section 13 and within inlet flow path 16 such that the working fluid 201 is as cool as possible when it is emitted into the lower section 17 and such that heat transfer from the formation 6 to the working fluid 201 is delayed (or substantially delayed) until the working fluid 201 is flowing within lower section 17 (and particularly as the fluid is flowing upward toward lower end 14b of outlet string 14). This may be accomplished by use of suitable insulation (e.g., including vacuum insulation systems or arrangements) within upper section 13 (e.g., such as around outlet string 14) and/or around inlet flow path 16 in some embodiments. In particular, inlet flow path 16 may comprise heavy insulation so as to prevent (or at least restrict) heat from transferring into the working fluid 201 from the formation 6 until it is emitted into lower section 17 via inlet flow path 16.

In addition, as shown in FIG. 1, the working fluid 201 may be emitted into lower section 17 via inlet flow path 16 at a point that is downhole from the lower end 14b of outlet string 14 so that heating of the working fluid 201 may occur within the working fluid 201 as it flows upward within lower section toward outlet string 14 (e.g., via natural convection). Further, the outlet string 14 may also be insulated so as to prevent (or at least restrict) cooling of the working fluid 201 as it flows upward toward surface 4 within outlet string 14 during operations. In some embodiments, the temperature of the working fluid 201 exiting the inlet flow path 16 into the lower section 17 may be approximately 200-220° F. Additional heating of the working fluid 201 may then occur as the working fluid 201 flows uphole through lower section 17 into lower end 14b of outlet string 14 so that the temperature of the working fluid 201 is increased further (e.g., close to or over 300° F. in some embodiments).

Referring still to FIG. 1, following the initial charging of working fluid 201 within the system 10 (e.g., including wellbore 12 and power generation assembly 100), additional actions may be taken to initiate the thermosiphon effect of bubble pump 18 for lifting the hot working fluid 201 to the surface 4 within outlet string 14 as previously described. For instance, in some embodiments, a pump (not shown) (e.g., pump 148 shown in FIG. 2 and discussed below) may be utilized to flow a sufficient volume of the working fluid 201 into the upper section 13 so as to displace hot working fluid 201 within the lower section 17 and/or the outlet string 14 (e.g., proximate lower end 14b) toward the surface 4 and initiate the boiling and gas lift process as previously described. Once the thermosiphon effect has been initiated within the outlet string 14, the pumping of working fluid 201 into the upper section 13 may be ceased but the working fluid 201 will continue to circulate within the wellbore 12 and power generation assembly 100 via bubble pump 18 as previously described.

In some embodiments, gas may be injected into outlet string 14 (e.g., at a point within the upper section 13) that may lower the density of the working fluid 201 within the outlet string 14 and thereby initiate a flow upward toward surface 4. The upward flow of working fluid 201 within the outlet string 14 may draw hot working fluid 201 upward from lower section 17 via outlet string 14 to a sufficient depth to initiate the boiling and gas lift process as previously described. As previously described, the working fluid 201 may comprise an ammonia-water mixture. Thus, in some embodiments, the initial volume of gas injected into outlet string 14 to initiate the thermosiphon effect may comprise pure (or substantially pure) ammonia gas. The pure ammonia gas may be injected at a point along outlet string 14 where the pressure is sufficiently low enough for the injected ammonia gas to boil. In some of these embodiments, once the thermosiphon effect is initiated within outlet string 14, the amount of injected gas (e.g., ammonia) may be reduced within the working fluid 201 to achieve a proper balance (described in more detail below) of components for efficiently operating the power generation assembly 100.

Without being limited to this or any other theory, when a TEG is included within power generation assembly 100 the water within the working fluid 201 may provide a sufficient heat capacity to carry large amounts of heat from the formation 6 to the TEG within power generation assembly 100, while the ammonia (e.g., after being re-condensed) may serve as a suitable refrigerant for exposing the TEG to lower temperatures (thereby achieving the temperatures gradient across the TEG as previously herein). Accordingly, a balance may be maintained between the relative amounts of ammonia and water so as to ensure reliable initiation of the thermosiphon and bubble pump effects and also to ensure a sufficient temperature gradient across the TEG within the power generation assembly 100 during operations. In some embodiments, a suitable balance of ammonia and water within the working fluid 201 may comprise 75 percent by weight (“weight %”) ammonia and 25 weight % water. However, other embodiments may utilize different amounts of ammonia and water, such as, for example, about 20-40 weight % ammonia and about 60-80 weight % water. Without being limited to this or any other theory, in some embodiments a working fluid 201 may include a relatively smaller portion of ammonia (e.g., about 20-40 weight % as previously described for some embodiments) for wellbores having relatively high temperatures (e.g., above 300° F.).

Referring now to FIG. 2, an embodiment of power generation assembly 100 for use within geothermal power generation system 10 (FIG. 1) is shown. As previously described, the power generation assembly 100 includes a fluid circuit 104 that is to receive a flow of working fluid 201 therethrough to generate electricity. In some embodiments, the components of power generation assembly 100 may be positioned at the surface (e.g., surface 4 shown in FIG. 1).

In describing the components and operations of power generation system 100 shown in FIG. 2, the working fluid 201 will be assumed to be an ammonia-water mixture as previously described. However, this should not be interpreted as limiting for other potential mixtures or components of working fluid 201 for other embodiments of power generation system 100.

Fluid circuit 104 of power generation assembly 100 is coupled to the inlet line 101 and outlet line 103 for routing fluid into wellbore 12 and receiving fluid routed from wellbore 12 as previously described. Starting with the outlet line 103, the hot working fluid 201 emitted from wellbore 12 (FIG. 1) may be routed along fluid circuit 104 first to a separator 110 that may separate the gas and liquid components of working fluid 201. The separated gases may flow out of separator 110 via a first outlet line 112, and the separated liquids may flow out of separator 110 via a second outlet line 114. In some embodiments, the gases flowing out of separator 110 via first outlet line 112 may comprise ammonia and potentially some water vapor (or may comprise substantially pure ammonia), and the liquids flowing out of separator 110 via the second outlet line 114 may comprise a relatively weaker solution aqueous ammonia solution (e.g., that comprises less than approximately 75 weight % ammonia, such as for instance about 60 weight % ammonia) compared to that of the working fluid 201 when it is flowing within lower section 17 of wellbore 12.

The liquids flowing out of separator 110 via outlet line 114 are routed across a first side 102a of a TEG 102. As previously described, the working fluid 201 entering separator 110 via outlet line 103 may be at a high temperature as a result of flowing through the wellbore 12 (particularly the lower section 17) (FIG. 1). As a result, the liquids flowing through outlet string 14 may expose the first side 102a of the TEG 102 to this high temperature. In some embodiments, the first side 102a of TEG 102 may be exposed to temperatures ranging from about 180° F. to about 300° F. (or more). Accordingly, the first side 102a may also be referred to herein as a “hot side 102a” of TEG 102.

After flowing along first (or hot) side 102a of TEG 102, the liquids are then routed along line 116 to an absorber 150, where the liquids are contacted by a counterflowing stream of gaseous mixture of ammonia and a light gas. In some embodiments, the light gas may comprise helium or hydrogen. In the following description, the light gas will be assumed to be helium for simplicity. While in the absorber 150, the water may absorb the ammonia component of the gaseous ammonia and helium mixture such that a relatively strong solution of liquidous ammonia-water mixture (e.g., comprising approximately 75 weight % and a remaining balance of water and possibly other impurities) is emitted from absorber to a tank 140 via a line 128.

Returning to separator 110, the separated gases may flow outward from separator 110 along first outlet line 112 to a condenser 120 that may cool the separated gases (e.g., via air cooler(s) and/or other heat exchange devices or medium(s)) to produce a liquid (or substantially liquid) stream of pure (or substantially pure) ammonia. In some embodiments, the gases flowing outward from separator 110 via first outlet line 112 are first routed through a partial condenser (such as a dephlegmator) to condense out additional water vapor and increase a purity of the ammonia gases flowing to condenser 120.

The pure (or substantially pure) ammonia liquid is then flowed along line 118 to an intersection (or junction 121) where the ammonia liquid is contacted by a stream of dry helium gas (or other light gas as previously described) via a line 122. The ammonia liquid and dry helium gas are then mixed as they progress together down a line 124 to an evaporator 130. In some embodiments, the ammonia liquid and dry helium gas may mix with one another within the evaporator 130 (e.g., rather than in line 124). Within the evaporator 130 the mixture of ammonia liquid and helium gases are expanded such that the ammonia expands (e.g., evaporates) or diffuses back into a gaseous state within evaporator 130. The evaporation of the ammonia liquid into gas within evaporator 130 cools the ammonia significantly (e.g., −40° F. to 0° F. in some embodiments).

The evaporator 130 may be positioned along a second side 102b of the TEG 102 that is opposite the first side 102a. Thus, the cool evaporated ammonia with the evaporator 130 may expose the second side 102b of TEG 102 to relatively cool temperatures. Accordingly, the second side 102b may also be referred to herein as a “cold side 102b” of TEG 102.

After the cool ammonia and helium mixture (which may be substantially gaseous) exits the evaporator 130, it may flow via line 126 to the tank 140. A bypass line 125 may between line 126 and line 118, upstream of junction 121 that is to allow excess ammonia liquid (e.g., in the event of an overproduction of ammonia liquid in the condenser 120) to bypass the evaporator 130. In addition, the bypass line 125 may also provide a flow path for helium that is purged from the condenser during start up. Specifically, when the power generation assembly 100 is not running, helium gas may settle in the condenser, and this gas may be purged out of the condenser, via bypass line 125, when the bubble pump 18 within wellbore 12 (FIG. 1).

Within tank 140, the helium gases may separate from the ammonia and flow out of tank via the line 128 and through absorber 150 in a counterflow arrangement with the ammonia and water flowing through absorber 150 and into tank 140 via line 128 as previously described. Specifically, gaseous ammonia and helium that flows out of evaporator 130 via line 126 may displace fluid (e.g., gas) through line 126, tank 140, and back through line 128 and into absorber 150 (e.g., so as to form a U-tube with the lines 126, 128, tank 140 and absorber 150). Within the absorber 150, the ammonia and helium gases are flowed counter to the liquid solution flowing into absorber 150 via line 116 such that ammonia is transferred into the liquid solution and form a strong aqueous ammonia solution (e.g., having approximately 75 weight % ammonia as previously described) that eventually flows into tank 140 via line 128.

Dry helium gases that are emitted from the absorber 150 may then flow back up the line 116 to a junction 123 that is coupled to line 122 for flowing the dry helium to the junction 121 for mixing with the liquid ammonia emitted from condenser 120 as previously described. Thus, during operations with power generation assembly 100, helium is circulated between the evaporator 130, tank 140, and absorber 150 in a continuous loop so as to facilitate the evaporation (or diffusion) of the liquid ammonia within evaporator 130 as previously described.

Referring still to FIG. 2, the ammonia and water mixture comprising the working fluid 201 within the tank 140 may be flowed back toward inlet line 101 via a line 142. Once the working fluid 201 is emitted via inlet line 101, it is then directed back into wellbore 12 (FIG. 1) to once again absorb heat from the subterranean formation (e.g., formation 6) as previously described above.

Another outlet line 132 may extend from tank 140 to a waste ammonia container 133. In some embodiments, the line 132 and waste ammonia container 133 may be used to remove excess ammonia from the working fluid 201 for purposes of achieving a desired balance of components in the working fluid 201 for efficient operation of power generation assembly 100 as previously described above. In addition, an additional port 119 coupled to line 118 may be used to remove (or inject) ammonia within the power generation assembly 100 during operations.

In addition, in some embodiments a pumping or charging loop 141 is coupled to the line 142, downstream of tank 140. Charging loop 141 includes a bypass line 146 that is coupled to line 142 at a first junction 147 and a second junction 149. The first junction 147 and second junction 149 may be spaced from one another along line 142 such that first junction 147 may be positioned between the tank 140 and second junction 149, and the second junction 149 is positioned between the first junction 147 and the inlet line 101. A valve 145 is positioned on line 142, between the first junction 147 and the second junction 149. During operations, the valve 145 may be closed to force working fluid 201 flowing from tank 140 to flow along the bypass line 146 and back into line 142 at second junction 149.

A pump 148 is positioned along bypass line 146. The pump 148 may comprise any suitable pumping device (or collection of devices) (e.g., a positive displacement pump, centrifugal pump, etc.). A first valve 144 is positioned along bypass line 146, between first junction 147 and pump 148, and a second valve 143 is positioned along bypass line 146 between pump 148 and second junction 149. In some embodiments, a pulsation dampener 160 is coupled to bypass line 146, between pump 148 and second valve 143 that may dampen pressure pulsations that are emitted from pump 148 (e.g., such as in the case where pump 148 is a positive displacement pump).

Referring now to FIGS. 1 and 2, during operations, the valves 145, 144, 143 may be actuated to flow working fluid 201 through the pump 148 toward the inlet line 101. Specifically, charging loop 141 may be utilized to initially start the flow of working fluid 201 out of inlet 101 and through wellbore 12 so as to initiate the thermosiphon effect of bubble pump 18 within wellbore 12 as previously described. Once the thermosiphon effect is established and working fluid 201 is being circulated between wellbore 12 and power generation assembly 100 as previously described, the pump 148 may be disabled and the valves 145, 144, 143 may be actuated to allow working fluid 201 flowing from tank 140 along line 142 to bypass charging loop 141 and flow directly to inlet line 101. In some examples, the charging loop 141 (or parts thereof such as the pump 148) may be disconnected and removed from power generation assembly 100 once circulation of working fluid 201 has been initiated.

Referring again to FIG. 1, as described above, as working fluid 201 (e.g., comprising ammonia and water) and helium is circulated along fluid circuit 104 within power generation assembly 100, the hot side 102a and cold side 102b of TEG 102 are exposed to hot and cold temperatures such that a relatively large temperature difference or gradient is established between the sides 102a, 102b. For example, in some embodiments, the temperature difference between the hot side 102a and cold side 102b may range from 175° F. to 340° F. Because the electrical current generation of thermoelectric generator 102 may be directly proportional to the temperature difference that is applied thereto, this relatively large temperature difference may allow thermoelectric generator 102 to generate a relatively large amount of electric current.

In some embodiments, some or all of the components of power generation assembly 100 may be placed within the wellbore 12 (FIG. 1). For instance, referring now to FIGS. 3A-3C, an embodiment of geothermal power generation system 200 (or more simply “system 200”) that includes a power generation assembly 300 positioned within upper section 13 of the wellbore 12 is shown. In principle, the operation of geothermal power generation system 200 is similar to that of geothermal power generation system 10 shown in FIG. 1; however, components of power generation assembly 300 may be altered from that shown and described above for power generation assembly 100 so as to allow power generation assembly 300 to be placed within wellbore 12. As shown in FIG. 3A, a wellhead 211 is positioned at the surface 4 that may provide pressure and fluid containment for wellbore 12 while also providing access point/ports into the wellbore 12 and flow paths defined therein.

The power generation assembly 300 include a fluid circuit 304 that is fluidly coupled to, and thus in fluid communication with, the wellbore 12 and is configured to circulate a working fluid 201 therethrough to generate electricity as previously described. Referring specifically to FIG. 3C, initially, a working fluid 201, is flowed through a packer 220 via an inlet flow path 216 into lower section 17 of wellbore 12 (that extends from packer 220 to lower end 12b as previously described). As previously described, in some embodiments, the working fluid may comprise an ammonia-water mixture (and thus, in describing the system 200 and assembly 300, the working fluid will be assumed to be such an ammonia water mixture to simplify the description). Thereafter, the working fluid 201 may flow upward within lower section 17 toward an outlet string 214 also extending through packer 220. As the working fluid 201 flows within the lower section 17 toward outlet string 214, the relatively high heat of the formation 6 surrounding lower section 17 may increase the temperature of the working fluid as previously described above for system 10.

As was previously described for the inlet flow path 16 in the system 10 shown in FIG. 1, the inlet flow path 216 may be insulated so as to prevent (or restrict) heat transfer from the formation 6 into the working fluid 201 until the working fluid 201 is emitted into the lower section 17 of the wellbore 12. Preventing (or restricting) heating of the working fluid 21 while flowing within the inlet flow path 216 may facilitate the thermosiphon effect for the working fluid 201 as previously described.

Referring now to FIGS. 3A-3C, the hot working fluid 201 progresses upward within the outlet string 14 and eventually reaches a depth (and corresponding head pressure) that allows the hot working fluid 201 to boil and form a slugged flow as previously described (e.g., such that a thermosiphon effect is established within the outlet string 214). As a result, the outlet string 214 and inlet flow path 216 may form a so-called “bubble pump” 318 within wellbore 12 in a similar manner to that described above and shown in FIG. 1.

As shown in FIG. 3B, the slugged flow (of intervening slugs of liquid and gases) continues to progress upward within the outlet string 214 until reaching a first or downhole outlet 222 that emits the liquid components 201a of the working fluid 201 from the outlet string 214 into an annular region 203 surrounding outlet string 214. The gas component 201b of the working fluid 201 continues upward within outlet string 214 until reaching a second or uphole outlet 223 that directs the gas component into another annular region 205 surrounding outlet string 214. Thus, the portion of outlet string 214 that includes the downhole (e.g., liquid) outlet 222 and the uphole (e.g., gas) outlet 223 may define a separator that operates similarly to the separator 110 shown in FIG. 2.

The liquid component 201a of the working fluid 201 may comprise water with potentially some liquid ammonia mixed therein. By contrast, the gas component 201b may comprise mostly ammonia gas, such as pure (or substantially pure) ammonia gas. Thus, in the following description, the liquid component 201a may be referred to as water 201a (again which may comprise some liquid ammonia), and the gas component 201b may be referred to as ammonia 201b.

Referring now to FIGS. 3B and 3C, after flowing out of outlet string 214 via the downhole outlet 222, the hot water 201a of working fluid 201 may flow along first side 102a of TEG 102 such that the first side 102a (or hot side 102a) is exposed to relatively a high temperature as previously described. As shown in FIG. 3C, after the hot water 201a of working fluid 201 flows past first side 102a of TEG 102, the water 201a then flows into an outer annular region 250 surrounding the outlet string 214 that is uphole of the packer 220 and downhole of TEG 102. This annular region 250 may form an absorber that functions in a similar manner to the absorber 150 of power generation assembly 100 shown in FIG. 2. Thus, as the water 201a of working fluid flows through annular region 250, it is contacted by a helium (or other light gas) and ammonia mixture that allows ammonia to be reabsorbed by the water 201a to result in the ammonia-water mixture of the working fluid 201 as previously described. Further details of the other fluid flows within the annular region 250 are described more detail below.

Referring again to FIG. 3B, the gaseous ammonia 201b of working fluid 201 exits the outlet string 214 into the annular region 205 via the uphole outlet 223 as previously described. Thereafter, the ammonia 201b flows downhole through the annular region 205. Because the annular region 205 is at a higher depth than the lower section 17 of the wellbore 12 (FIG. 3C), the temperature of formation 6 surrounding annular region 205 may be less than that of the ammonia 201b. Thus, as the ammonia 201b flows downhole within the annular region 205, heat is transferred from the ammonia 201b to the formation 6 so that the temperature of the ammonia 201b is reduced and the ammonia 201b is condensed into a liquid. Accordingly, the annular region 250 functions as a condenser in a similar manner to the condenser 120 (and also the potential dephlegmator as previously described) shown in FIG. 2.

Referring still to FIG. 3B, after the cooled and liquidous ammonia 201b flows downhole through the annular region 205, it then progresses into an annular region 207 that surrounds and extends along the second side 102b of TEG 102. Dry helium gas may be supplied to the annular region 207 (e.g., from the absorber formed by the annular region 250 shown in FIG. 3C as is described in more detail below). Thus, as the liquid ammonia 201b contacts the dry helium, the liquid ammonia 201b may diffuse into the helium as a gas, thereby resulting in a significant drop in temperature as previously described. As a result, the annular region 207 functions as an evaporator similar to the evaporator 130 shown in FIG. 2.

The cold temperature of the diffused gaseous ammonia 201b may expose the second side 102b (or cold side 102b) of the TEG 102 to relatively cold temperatures as previously described. As a result, the TEG 102 is exposed to a temperature gradient between the sides 102a, 102b that causes TEG 102 to generate an electric current that is conducted via conductors 215 back to the upper end 12a of wellbore 12 (and thus the surface).

Referring now to FIG. 3C, the ammonia 201b and helium mixture may then progress downhole out of the annular region 207 and into the annular region 250 to contact the water 201a as previously described. Within the annular region 250 the gaseous ammonia 201b of working fluid may be reabsorbed into the water 201a, thereby leaving the helium gas to flow back uphole into the annular region 207 to once again contact ammonia 201b along the second side 102b of TEG 102 as previously described.

A flow restriction 252 may be inserted within the annular region 250, about the outlet string 214 so as to promote mixing (and therefore contact) between the ammonia 201b, helium, and water 201a as previously described. In some embodiments, the flow restriction 252 comprises chain that is coupled to an outer surface of outlet string 214; however, other suitable flow restrictions (e.g., baffles) may be used in other embodiments.

Referring still to FIG. 3C, the recombined working fluid 201 (including the re-mixed ammonia 201b and water 201b) may then flow back downhole in a substantially liquid state toward packer 220. Thereafter, the working fluid 201 may progress through packer 220 into lower section 17 via the inlet flow path 216 to restart the process.

Referring now to FIG. 4, a geothermal power generation system 350 (or more simply “system 350”) according to some embodiments is shown. System 350 generally includes wellbore 12 extending into subterranean formation from surface 4 as previously described, and a power generation assembly 400 positioned at the surface 4 that is fluidly coupled to wellbore 12.

The outlet tubular string 14, packer 20, and inlet flow path 16 shown in FIG. 1 may be replaced with an outlet tubular string 414 (or more simply “outlet string 414”) that extends into the wellbore 12 from surface 4. The outlet string 414 may comprise any suitable tubular member including, for instance, coiled tubing, pipe (e.g., comprised of threadably coupled tubular members), etc. The outlet string 414 may extend through a wellhead or other suitable seal 415 positioned at (or near) the surface 4 that is to fluidly separate the wellbore 12 from the outside environment at surface 4. In addition, outlet string 414 has an first or upper end 414a that is positioned at the surface 4, outside of the wellbore 12, and a second or lower end 414b that is positioned within the wellbore 12. In some embodiments, the downhole end 414b is positioned more proximate the lower end 12b than the upper end 12a of wellbore 12 along axis 15. Insulation 416 may cover (or partially cover) the outlet string 414 within the wellbore 12. An annulus 418 is defined within wellbore 12 circumferentially about the outlet string 414 that extends from wellhead 415 down to lower end 414b.

The outlet string 414 may define an outlet flow path that extends from wellbore 12, proximate lower end 12b, to the outer environment outside of wellbore 12 at the surface 4. In addition, the annulus 418 defines an inlet flow path into wellbore 12 that extends from upper end 12b downhole to the lower end 414b of outlet string 414.

During operations, working fluid 201 is circulated between power generation assembly 400 and wellbore 12 for electrical power generation. In some embodiments, the working fluid 201 may comprise a refrigerant, such as R-245fa or propane, as previously described above.

During operations, the working fluid 201 may be flowed into wellbore 12 and downhole via annulus 418 to the lower end 414b of outlet string 414. As the working fluid 201 flows downhole within annulus 418, the heat of the formation 6 may increase the temperature of the working fluid 201 above a boiling point thereof (e.g., a boiling point of some or all of the components of working fluid 201). However, the pressure within wellbore 12 at the lower end 414b of outlet string 414 may prevent the working fluid 201 from boiling. After entering the lower end 414b of outlet string 414, the working fluid 201 flows axially upward along outlet string 414 to upper end 414a. The insulation 416 may restrict heat transfer away from the working fluid 201 within outlet string 414. Thus, as the working fluid 201 flows uphole within outlet string 414, the working fluid 201 (or one or more components thereof) may begin to boil so that a thermosiphon effect is generated between the annulus 418 and outlet flow string 414 in a similar manner to that described above for the embodiment of wellbore 12 shown in FIG. 1. Accordingly, the pressure difference generated between the lower density column of working fluid 201 in the outlet string 414 and the higher density column of working fluid 201 in the annulus 418 may drive flow or circulation of the working fluid 201 within the wellbore 12 without the aid of an additional pump. Thus, the annulus 418 and outlet string 414 may form a so-called “bubble pump” 419 within the wellbore 12.

Referring still to FIG. 4, the power generation assembly 400 includes a fluid circuit 403 that is fluidly coupled to, and thus in fluid communication with, the wellbore 12 (particularly to annulus 418 and outlet string 414). Thus, a fluid loop or circuit 405 is established that includes and extends between fluid circuit 403 and wellbore 12 (particularly to annulus 418 and outlet string 414), and the working fluid 201 is circulated along fluid loop 405 so as to drive electricity generation via power generation assembly 400.

During operations, the working fluid 201 may be circulated through the fluid circuit 403 so that power generation assembly 400 may generate electricity. Specifically, the hot working fluid 201 may enter the fluid circuit 403 of power generation assembly 400 via an inlet line 401. The inlet line 401 flows the working fluid 201 through a nozzle 404 and then into a turbine 402 that is to convert the relatively high pressure of the hot working fluids 201 into mechanical work. The nozzle 404 induces a pressure drop and subsequent phase change, which controllably expands the working fluid 201 within the turbine 402. The turbine 402 may be coupled to a shaft 406 that is rotated via the flow of working fluid 201 through turbine 402 during operations. The shaft 406 may be coupled to an electrical generator 408 so that a rotation of the shaft 406 may drive electricity generation within the generator 408. Thus, the turbine 402 is mechanically coupled to generator 408 via shaft 406. As previously described, the electricity generated by generator 408 may be conducted to a final location (e.g., final location 50 shown in FIG. 1 and described above).

Turbine 402 may comprise any suitable design. For instance, in some embodiments, turbine 402 may comprise a reaction turbine. In some embodiments, the turbine 402 may comprise an axial turbine or impulse turbine such as a so-called variable phase turbine (VPT). Regardless of the particular design or form of turbine 402, during operations, the flow of the working fluid 201 through the turbine 402 may drive rotation of shaft 406 such that electricity may be generated by generator 408 as previously escribed. Accordingly, as working fluid 201 flows through turbine 402, energy is transferred from the working fluid 201 to the shaft 406 such that the temperature and pressure of the working fluid is reduced.

The lower pressure working fluid 201 is emitted from turbine 402 and then is flowed to a heat exchanger 410 that reduces the temperature of the working fluid 201 such that all or most of the working fluid 201 is converted back to a liquid. Thus, the heat exchanger 410 may be referred to herein as a “condenser.”

Heat exchanger 410 may comprise any suitable design for reducing a temperature of working fluid 201. For instance, in some embodiments, heat exchanger 410 may comprise an air cooler that flows air over the surface of tubing which carries the working fluid therethrough. The air flow may be generated by a fan 412 that is driven by a motor 413. In some embodiments, the motor 413 may be driven by electricity generated by the generator 408. In some embodiments, the heat exchanger 410 may comprise an evaporative cooler that cools the working fluid 201 via the evaporation of a heat exchange fluid (e.g., water). In some embodiments, the heat exchanger 410 may comprise a shell-and-tube heat exchanger that circulates a cooling fluid to reduce a temperature of working fluid 201 during operations.

The cooled working fluid 201, which may be mostly or completely liquid as previously described, may be emitted from the heat exchanger 410 and flowed to a pump 420 which pressurizes and emits the working fluid 201 into an outlet line 403. The outlet line 403 communicates the working fluid 201 back to the annulus 418 such that the working fluid 201 may be recirculated through the wellbore 12 as previously described above.

In some embodiments, the pump 420 may be operated or driven via electrical power that is generated by generator 408. In addition, as previously described, in some embodiments pump 420 may be utilized to initiate the flow of working fluid 201 between the wellbore 12 and power generation assembly 400, but then may be deactivated once the thermosiphon affect begins driving flow of the working fluid 201 as previously described. In some embodiments, pump 420 may continue to operate, but at a reduced capacity once the thermosiphon affect is initiated within wellbore 12. In some embodiments, a bypass line 422 may be included that is to allow working fluid 201 to selectively bypass the pump 420 when pump 420 is deactivated. One or more valves (not shown) may be included upstream, downstream, and/or along the bypass line 422 to allow flow to be selectively routed through pump 420, bypass line 422 or both during operations. Thus, during operations, pump 420 may be actuated so as to initiate the flow of working fluid 201 until the thermosiphon affect is established via the bubble pump 419 within in wellbore 12 as previously described. Thereafter, pump 420 may be deactivated and the one or more valves (not shown) may be actuated to direct the fluid through bypass line 422 around pump 420.

As described above, some embodiments disclosed herein include systems and methods for generating electrical power from the geothermal energy emitted into a subterranean wellbore. Accordingly, through use of these embodiments, the geothermal energy of the earth may be efficiently harnessed to generate electrical power.

While specific embodiments discussed above include use of a bubble pump arrangement within a subterranean wellbore (e.g., wellbore 12) for transferring the heat of the subterranean formation (e.g., formation 6) for electrical power generation, in some embodiments, the bubble pumps may be used to transfer the heat of the subterranean formation for other purposes. For instance, embodiments of the bubble pumps described herein (e.g., FIGS. 1 and 3A-3C) may be utilized to transfer heat from formation 6 for use in a water desalinization plant. In some embodiments, the embodiments of the bubble pumps described herein may be utilized to transfer heat from formation 6 for use in heat exchanger, turbine, or other apparatus or system.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A system, comprising:
a wellbore that extends from a surface into a subterranean formation;
a power generation assembly comprising a fluid circuit that is in fluid communication with the wellbore wherein the power generation assembly is configured to generate electricity in response to a flow of a working fluid through the fluid circuit; and
a bubble pump positioned within the wellbore that is configured to circulate the working fluid between the fluid circuit of the power generation assembly and the wellbore via a thermosiphon effect.

2. The system of claim 1, wherein the bubble pump comprises:
a first flow path that extends from the surface toward a lower end of the wellbore; and
a second flow path that extends from the first flow path toward the surface.

3. The system of claim 2, comprising a tubular string extending into the wellbore from the surface, wherein the first flow path extends through an annulus formed outside the tubular string and wherein the second flow path extends through the tubular string.

4. The system of claim 2, comprising a packer positioned within the wellbore that is configured to define a first section above the packer and a second section below the packer,
wherein the first flow path extends through the packer from the first section to the second section, and wherein the second flow path extends through the packer from the second section toward the surface.

5. The system of claim 2, wherein the power generation assembly comprises:
a turbine that is fluidly coupled to the wellbore; and
an electrical generator mechanically coupled to the turbine.

6. The system of claim 5, wherein the turbine comprises a variable phase turbine.

7. The system of claim 2, wherein the power generation assembly comprises a thermoelectric generator (TEG) that is configured to receive a flow of the working fluid therethrough and to generate electricity.

8. The system of claim 1, wherein the power generation assembly is positioned on the surface.

9. The system of claim 1, wherein the power generation assembly is positioned within the wellbore.

10. The system of claim 1, wherein the working fluid comprises an ammonia-water mixture, pentafluoropropane, or propane.

11. A method, comprising:
(a) circulating a working fluid between a wellbore and a power generation assembly via a thermosiphon effect, wherein the wellbore extends from a surface into a subterranean formation;
(b) flowing the working fluid through a fluid circuit of the power generation assembly; and
(c) generating electricity with the power generation assembly as a result of (b).

12. The method of claim 11, wherein (a) comprises:
(a1) flowing the working fluid along a first flow path that extends from the surface toward a lower end of the wellbore; and
(a2) flowing the working fluid along a second flow path that extends from the first flow path toward the surface after (a1).

13. The method of claim 12, wherein (a2) comprises boiling the working fluid as the working fluid flows along the second flow path.

14. The method of claim 11, wherein (b) comprises:
(b1) flowing the working fluid through a turbine; and
(b2) actuating a generator that is mechanically coupled to the turbine during (b1).

15. The method of claim 11, wherein (b) comprises:
(b3) flowing the working fluid through a thermoelectric generator (TEG); and
(b4) generating electricity with the TEG during (b3).

16. The method of claim 11, wherein the power generation assembly is positioned on the surface.

17. The method of claim 11, wherein the power generation assembly is positioned within the wellbore.

18. A system, comprising:
a wellbore that extends from a surface into a subterranean formation;
a power generation assembly comprising a generator and a turbine mechanically coupled to the turbine, wherein actuation of the turbine is configured to actuate the generator to generate electricity; and
a bubble pump positioned within the wellbore that is configured to circulate a working fluid between the turbine and the wellbore via a thermosiphon effect to actuate the turbine.

19. The system of claim 18, wherein the bubble pump comprises:
a tubular string extending into the wellbore from the surface;
a first flow path that extends from the surface toward a lower end along an annulus formed outside of the tubular string; and
a second flow path that extends from the first flow path toward the surface through the tubular string.

20. The system of claim 19, wherein the turbine comprises a variable phase turbine.
